(19) United States
(12) Patent Application Publication
(10) Pub. No.: US 2005/0164145 A1
(43) Pub. Date: Jul. 28, 2005

(54) Audio Detection for use with Dental Tools

(76) Inventor: Jack Cash JR., Deerparks, TX (US)

Correspondence Address: JEFFREY FURR, 253 N. MAIN STREET, JOHNSTOWN, OH, 43031, US

(21) Appl. No.: 10/707,967

(22) Filed: Jan. 28, 2004

(51) Int. Cl. A61C 3/03; A61C 3/00

(52) U.S. Cl. 433/119; 433/114

(57) ABSTRACT

The present invention relates to a dental device having an electronic audio sensor that allows a dentist to hear the hard deposits and rough surfaces on teeth. The sensor uses a female friction fitting means to connect to the male end of the dental instrument. A wire connects the sensor to an electronic package that converts the sensor information into sounds. The sounds aid the operator in determining the condition of the patient″s teeth. The electronic package has a volume control with an on/off switch and a clip that can be attached to a belt, pocket, or any desired place of attachment. The unit is powered by a 1.5 volt button-type battery located in the electronic package. The sensor, wire, and electronic package have a total weight of 1.5 ounces. Headphones are plugged into a headphone receptacle. The headphones include an inline volume control to fine-tune the sound passing through the sensor. Different instruments can be quickly changed as the procedure is performed. Fittings other than friction fittings may be used.

### BACKGROUND OF INVENTION

This invention relates to dental tools, and more specifically to a dental device having an electronic audio sensor that allows a dentist to hear the hard deposits and rough surfaces on teeth, especially below the gums.

### BACKGROUND

Root planing is when a dental instrument is applied to a root surface to divest the surface of deposits. When it is thoroughly performed, it can produce a smooth, clean, hard, polished root surface. Root planing is the primary treatment for periodontal inflammation. In many cases it may be the only treatment necessary or may be the only treatment that is feasible. In all other cases the patient is maintained after treatment by regular root planing and a program of plaque control. Since the removal of irritants is the definitive treatment for periodical inflammation, root planing is used more that any other type of periodical therapy.

Inflammation, pockets, tooth mobility, and tooth migration are the classical signs of periodical disease against which most therapy is directed. Root planing is a prerequisite for the cure of periodontal disease and with plaque control is an integral part of the effort to prevent the disease. When deposits are removed, the diseased dentogingival junction can heal. The inflamed tissue can be replaced by a young connective tissue consisting of reserve cells, other fibrous elements, and blood cells.

Most of gum surgery is done so that the dentist can see deposits on the roots. Gum surgery is done so that the dentist can see deposits on the roots. Gum surgery is very invasive and a lot won″t be necessary with current invention. Even with the gums pulled back, they are still bleeding so you can″t see anyway. The back teeth and the tongue side of teeth on the dentist″s side are difficult to see under any conditions. This is a real break for the eyes, back, and neck of the dentist.

There exists a need to give the dentists a new way to do root plane and scale procedures and a new way to detect any defective restorations when the instruments for these types of exams are used while reducing the need for perio surgery with better long term perio results.

There is also a need to take the pressure off the dentist″s vision. The bright dental light and eye strain of looking through magnification devices quickly degrades the dentist″s vision. Using hearing as a new way to do dental procedures will help prolong dental careers.

There is also a need for assisting in root planning in dental education. It takes a long time to develop the skills to perform dental procedures. The addition of sound to visual learning should really speed up the learning curve.

### DESCRIPTION OF PRIOR ART

Most prior art consists of ultrasonic cleaners. These devices use ultrasound at either 25 kHz or 30 kHz to vibrate a scaler tip. This system knocks big pieces of hard deposit off the teeth. Some of these patents are: U.S. Pat. No. Re. 29,687 for a scaler using to vibrate, U.S. Pat Nos. 4,110,908, 4,169,984, 3,488,851 and 3,518,766 for ultrasonic scalers, U.S. Pat. No. 3,654,502 for an ultrasonic scaler tip, U.S. Pat. No. 4,102,047 for a root canal teaching device, U.S. Pat. No. 4,179,816 for a device to pull caps off teeth, U.S. Pat. No. 4,382,786 for a hand piece to drill teeth, U.S. Pat. No. 4,403,956 for a hand piece with light for drilling, U.S. Pat. No. 4,589,847 for scaler using air to vibrate, U.S. Pat. No. 4,820,152 for an ultrasonic scaler that delivers antiseptic, U.S. Pat. No. 5,124,797 for a camera to look at teeth, U.S. Pat. No. 5,312,349 for a hand piece that delivers antiseptic, U.S. Pat. No. 5,582,162 for a sterilizable handle, U.S. Pat. No. 5,762,495 for a hand piece that delivers antiseptic, U.S. Pat. No. 5,927,977 for an ultrasonic cleaner that delivers all kinds of fluid, U.S. Pat. No. 5,947,729 for a dental cabinet containing all kinds of dental supplies, U.S. Pat. No. 6,264,470 for a Photometer to determine tooth color, and WO 98/2322/U.S. Pat. No. 5,927,977 for an ad for an ultra sonic cleaner.

There is still room for improvement in the art.

### SUMMARY OF INVENTION

The present invention relates to a dental device having an electronic audio sensor that allows a dentist to hear the hard deposits and rough surfaces on teeth. The sensor uses a female friction fitting means to connect to the male end of the dental instrument. A wire connects the sensor to an electronic package that converts the sensor information into sounds. The sounds aid the operator in determining the condition of the patient″s teeth. The electronic package has a volume control with an on/off switch and a clip that can be attached to a belt, pocket, or any desired place of attachment. The unit is powered by a 1.5 volt button-type battery located in the electronic package. The sensor, wire, and electronic package have a total weight of 1.5 ounces. Headphones are plugged into a headphone receptacle. The headphones include an inline volume control to fine-tune the sound passing through the sensor. Different instruments can be quickly changed as the procedure is performed. Fittings other than friction fittings may be used.

The device uses an aspect of instruments that has been ignored up to now. That aspect is the sound produced when instruments contact tooth surfaces. It does this by picking up the inaudible, faint sounds that instruments produce as they contact teeth. This sound is then processed and amplified. The result is an audible real-time sound that guides the dentist in performing his procedure. This is helpful in below the gum procedures and in areas that are difficult to access visually.

The object of this invention is to give the dentist a new way to do root plane and scale procedures and give the dentist a new way to detect any defective restorations when the instruments for these types of exams are used.

Another object of this invention is to be of ergonomic design and lightweight.

Another object of this invention is to be adaptable to any instrument. That is important because better instruments are produced all the time.

Another object of this invention is to reduce the need for perio surgery and have better long term perio results.

Another object of this invention is to take the pressure off the dentist″s vision. The bright dental light and eye strain of looking through magnification devices quickly degrades the dentist″s vision. Using hearing as a new way to do dental procedures will help prolong dental careers.

Another object of this invention is to assist in dental education. It takes a long time to develop the skills to perform dental procedures. The addition of sound to visual learning speeds up the learning curve.

### BRIEF DESCRIPTION OF DRAWINGS

Without restricting the full scope of this invention, the preferred form of this invention is illustrated in the following drawings:

FIG. 1 shows the basic component of the invention;

FIG. 2 shows a straight on view of the tool amplifier jack;

FIG. 3 shows the back of the amplifier means;

FIG. 4 shows a simplified circuit diagram of the device;

FIG. 5 shows the device being used on a tooth;

FIG. 6 shows a graph of the sound produced by the device when used on a tooth;

FIG. 7 shows a simplified circuit diagram with wireless communication; and

FIG. 8 shows some of the tools that can be used with the device.

### DETAILED DESCRIPTION

The following description is demonstrative in nature and is not intended to limit the scope of the invention or its application of uses.

There are a number of significant design features and improvements incorporated within the invention.

The current invention is a device that lies within the field of dentistry. More particularly in the area of dentistry known as periodontics. The specific area of periodontics is root plane and scale therapy. This treatment removes hard deposits from roots and smoothes them. Mechanical devices (ultrasonic scalers-also known as cavitrons) and hand scalers are used to do this.

The device 1 uses an aspect of hand scalers that has not been used before. Hand instruments produce faint sounds as they interact with teeth 5. These sounds, if processed through the device give the dentist an audio picture of what is happening as the dentist removes the hard deposits and smoothes the roots of teeth.

The device 1 uses a concept similar to the original phonographs. These phonographs had a record with groove. As the record spun at a certain speed, a needle tracked down the groove and vibrated a tiny bit to the bumps in the grooves. These bumps caused the needle to produce a faint sound. This tiny sound was then amplified and processed so that the listener could hear information contained on the record. In this analogy, the tooth 5 is the record, the scaler tip 9 is the needle of the phonograph, and the rest of the device 1 is the amplification and processing aspect of the phonograph.

This is important because most of gum surgery is done so that the dentist can see deposits on the roots. Gum surgery is very invasive and a lot won″t be necessary with current invention. Even with the gums pulled back, they are still bleeding so you can″t see anyway. The back teeth and the tongue side of teeth on the dentist″s side are difficult to see under any conditions. The dentist can easily hear what the tooth is telling you with our device. This is a real break for the eyes, back, and neck of the dentist. The device 1 will allow the patient to avoid gum surgery most times.

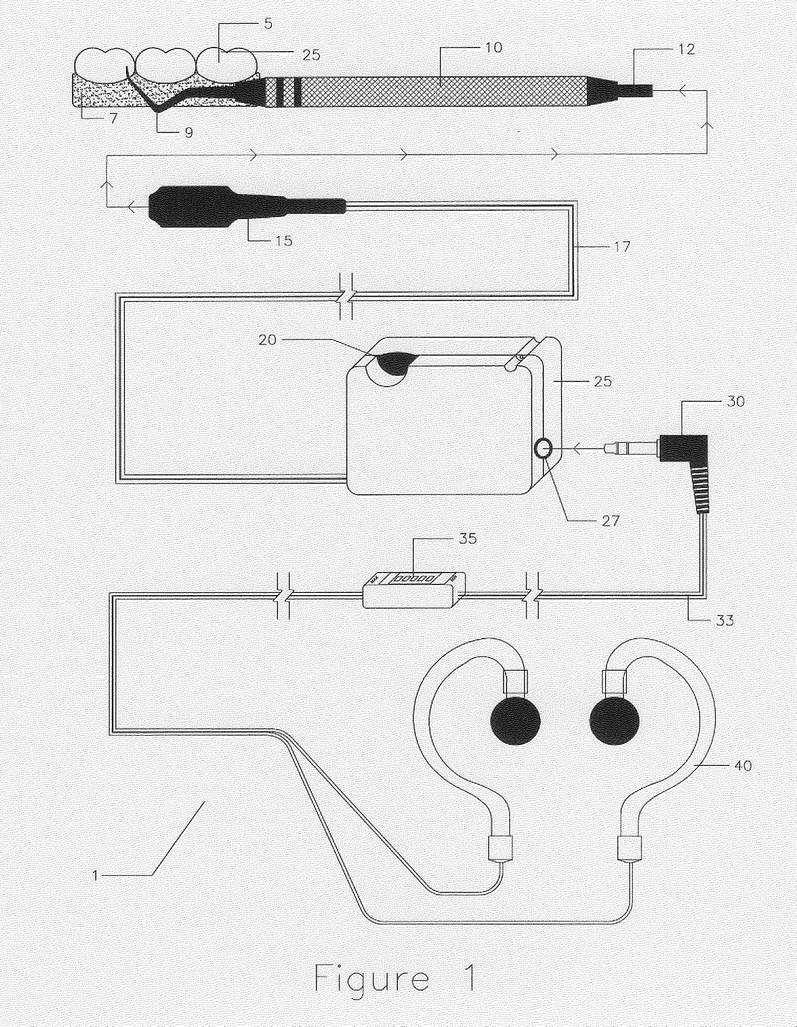

As shown in FIG. 1, there are three main parts of this device 1. First, there is a scaler 10. The scaler 10 is a long dental tool with a scaler tip 9 on one end and a scale male fitting 12 on the other.

Second, there is an amplification means 25. It has a female fitting 15 for the scaler 10 which is connected through the male fitting end 12 and a female plug-in 27 for headphones.

Third, there is a set of headphones 40 that plug into the amplification means.

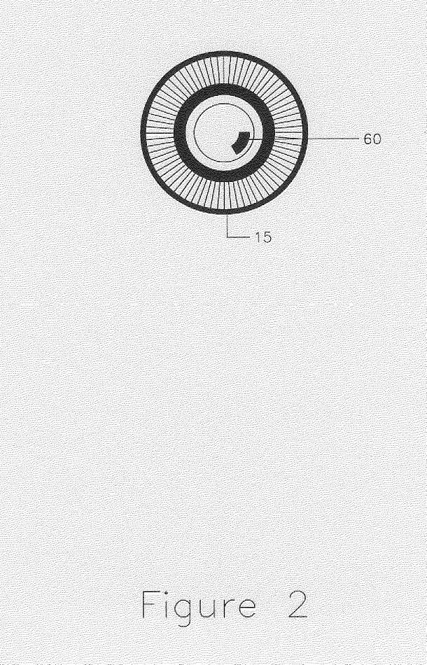

FIG. 2 displays the female pick-up 15 for the amplifier means 25. It has a condenser microphone 60 with a receptacle to pick up vibrations from the scaler 10. In the preferred embodiment, there is a metal disc inside the pick-up 15 that is drilled to receive the male end 12 of the scaler 10. The pick-up 15 connects to the amplifier means through the pick-up connecting means 17 which is a wire in the preferred embodiment.

The scaler 10 has a scaler tip 9 on one end and the male connector 12 on the other. The scaler 10 has an interference fit so that the many different shaped scalers 10 used during a procedure could be quickly changed out. In the preferred embodiment, the scaler 10 is made out of metal so that any connection is metal and easy to change out.

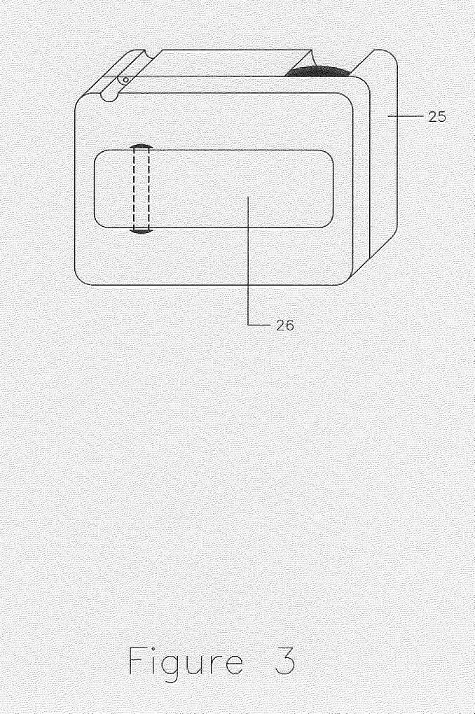

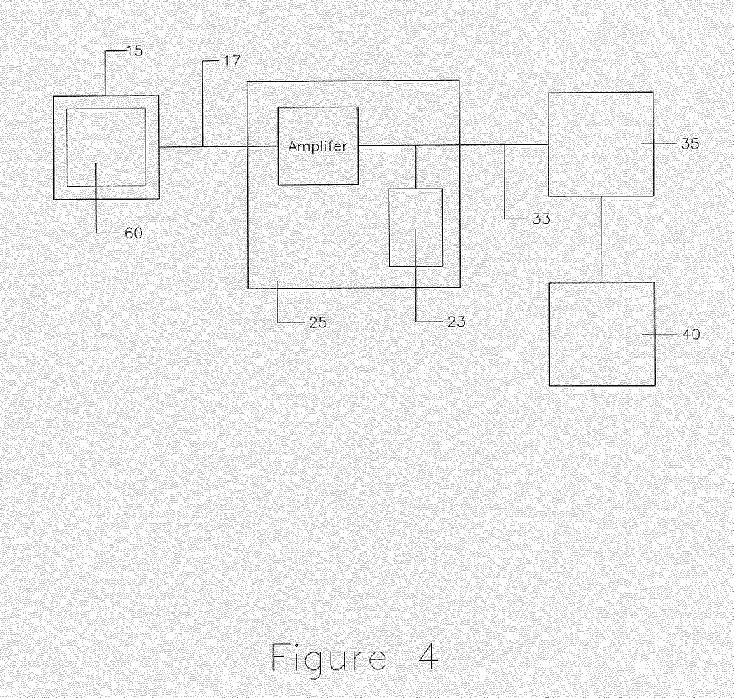

The amplifier means 25 is a standard amplifier device. It is a small size and light weight so that it is easy to stick into a pocket or clip 26 on to a belt. It has an on/off volume control 20 on this side. In the preferred embodiment, as shown in FIG. 3 the amplifier means 25 has a clip 26 for easy attachment to pocket, belt, etc. The amplifier means 25 has a ⅛^{th} inch female audio jack 27. The amplifier means 25 also contains the power source 23 such as a battery, a 1.5 volt button-type battery, for the device 1 as shown in the simple circuit diagram in FIG. 4.

The device 1 has a standard set of headphones 40 which connect to the amplifier 25 by using a jack 30 which plugs into the female audio jack 27. The headphone 40 has an in-line volume control 35. The right volume for the device 1 is possible because of the tuning between the amp volume 20 and the headphone volume control 35. This allows the device 1 to provide the proper tones and operator comfort.

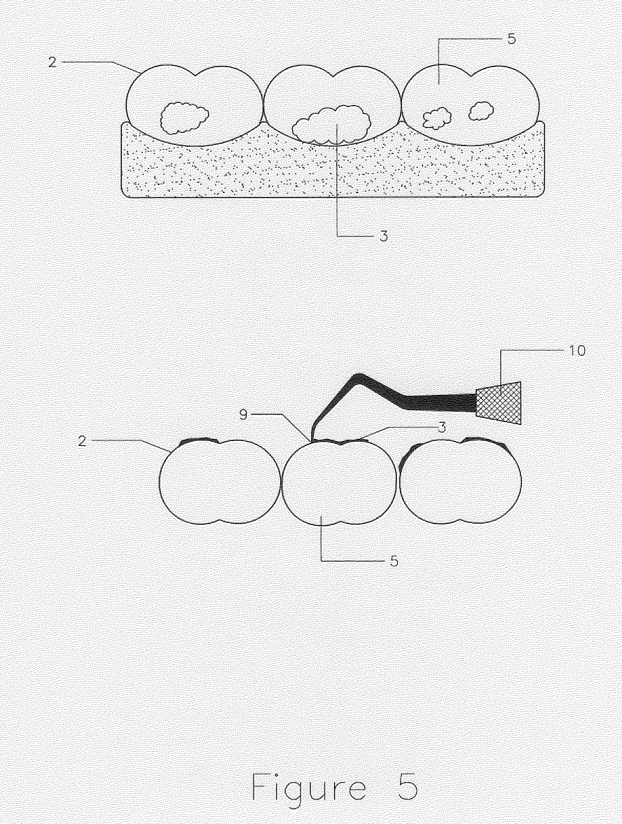

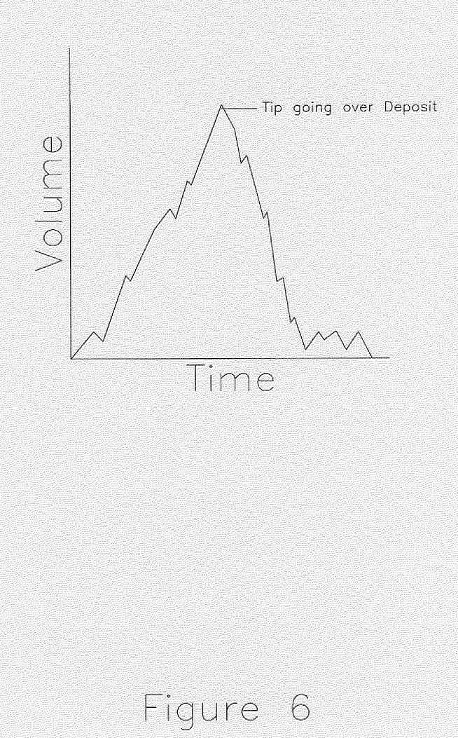

As shown in FIG. 5, the tooth 5 has deposits 3 on its surface 2. These deposits 3 rise up from the surface 2 of the tooth 5. When the tip 9 of the scaler 10 goes over these deposits 3 it causes the tip to vibrate and that transmits a sound to the user allowing the user to find the deposits 3 in order to remove them. FIG. 6 displays a graph of the sound that it transmitted when a user runs the tip 9 of the scaler over the deposits 3.

All instruments used in root planing are generally called scalers 10. The objectives of root instrumentation go beyond scaling for the removal of deposits, however. There are a number of different types of scalers 10, all which can be used with the device 1.

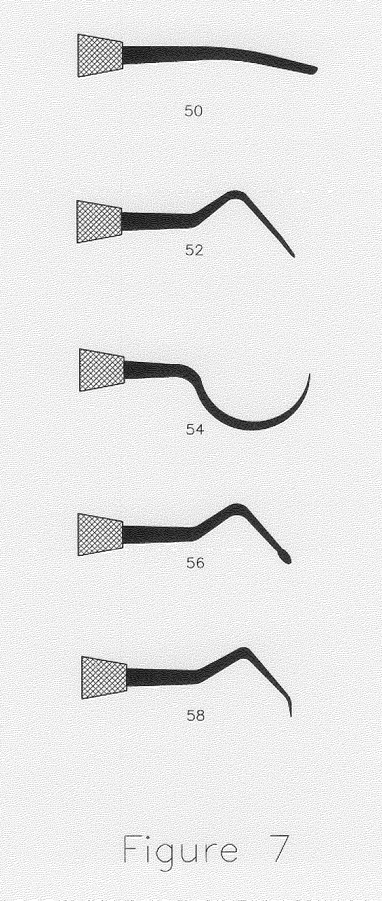

The names given to the instruments usually describe the shape and design of the blades or the mode of action of the instruments. There are five main groups: chisels, hoes, sickles, files, and curettes each designed for a specific use and sometimes for access to a specific tooth surface. The chisel, hoe, and sickle are designed for the removal of heavy calculus, where curettes and files are intended for the finer and final planing of the root surface to the bottom of the pocket. Samples of these instruments are displayed in FIG. 7.

The chisel 50 is designed for removal of extensive deposits, especially those located in the mandibular anterior region. Some chisels have very sharp corners that may nick the tooth surface and traumatize the tissues. These corners may be rounded without affecting the efficacy of the instrument.

The Hoe-shaped instruments 52 are intended for the removal of easily accessible calculus.

The sickle 54 is used on the lingual surface of mandibular incisors, an area difficult to reach with shorter instruments. The blades of some sickles are rectangular and extremely thin, sometimes as fine as 0.2 to 0.4 mm. They may be used in either a push or a pull stroke.

A File 56 is considered as having an action similar to that of three to five hoes. Files are designed for use in deep, narrow-mouthed pockets and in tortuous pockets inaccessible to other instruments.

Curettes 58 are spoon shaped with two cutting edges. They perform two functions: removing the soft tissue and serving as a root planer; sometimes they perform both functions simultaneously. The curette 58 is the most commonly used instrument for root planing and curettage. Its design permits easy entrance into pockets for the removal of deposits, and it is easily sharpened. Some of the more commonly used curettes are the Gracey and McCall types. The McCall instrument is primarily a pull curette; the Gracey is a push instrument.

Operation

When using the device 1 in the preferred embodiment you use the following steps: The user of the device 1 will take the components out of the packages. The main components are the scaler 10, the female friction fitting means 15 and fitting means connection wire 17, the electronic package 25 that converts the sensor information into sounds, headphones including the headphone plug 30, headphone wire 33, headphone volume control 3 and ear phones 40. The user plugs the headphone plug 30 into the headphone jack 27. The user clips the device 1 to a convenient place such as a pocket, patient, etc. The user plugs a Scaler 10 into the pigtail 15 on the device 1. The user makes sure that the headphones inline volume control 35 is on low. The user turns on the device 1 with its volume controller 20 on the electronic package 25. The user adjusts the volume to a comfortable level between the devices control 20 and the inline control 35 on the headphones 40. The user rubs the scalers 10 tip against a hard object such a sterilized metal tray to do this.

Once the user begins to scale, they can adjust as needed. The user can listen for calculus, defects, and cracks in roots and poor margins—all not visible by visual inspection.

Alternative Embodiments

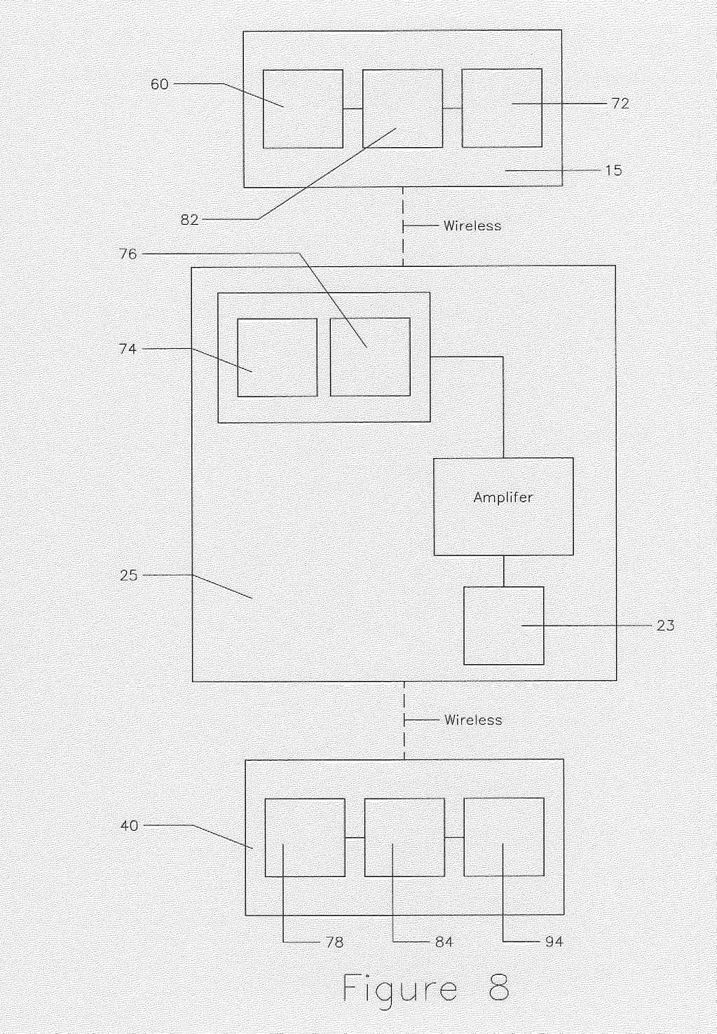

In an alternative embodiment as shown in FIG. 8, the connections between the pick-up 15 and the amplifier means 25 could be a wireless connection with the pick-up 15 having wireless transmitting means 72 and the amplifier means 25 having a wireless receiver 74. The connection between the amplifier means 25 and the headphones 40 can also be wireless with a wireless transmitter 76 in the amplifier means 25 and a wireless receiver 78 in the headphones 40 as well as a power source 94. The amplifier means 25 can have a wireless transmitter/receiver. This is shown in the simple circuit diagram in FIG. 7. The pick-up 15 would have its own power source 82 as would the headphones 84.

In another alternative embodiment, the headphones 84 can be replaced with an audio production device such as regular speakers.

Advantages

The previously described version of the present invention has many advantages. It gives the dentist a new way to do root plane and scale procedures. It gives the dentist a new way to detect any defective restorations when the instruments for these types of exams are used. It is ergonomic and lightweight. The amp and probe connector weigh 1.5 ounces total. It is adaptable to any instrument, which is important because better instruments are produced all the time. It reduces the need for perio surgery. The same results can be obtained without the need to see the root, which results in reduced misery for patient with better long term perio results. The invention takes the pressure off the dentist″s vision. The bright dental light and eye strain of looking through magnification devices quickly degrades the dentist″s vision. Using hearing as a new way to do dental procedures will help prolong dental careers. It assists in dental education, as it takes a long time to develop the skills to perform dental procedures and the addition of sound to visual learning should really speed up the learning curve.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A dental device comprising: a scaler attached to a pick-up means through a connecting means, said pick-up means connected to an amplifier means which is connected to audio production means.

2. A device as in claim 1 in which said audio production means is headphones.

3. A device as in claim 1 in which said amplifier means has a volume control.

4. A device as in claim 1 in which said pick-up means has a condenser microphone with a receptacle to pick up vibrations from said scaler.

5. A device as in claim 1 in which said audio production means has a volume control.

6. A device as in claim 1 in which said audio production means connects to said amplifier means through a plug being inserted into a plug jack.

7. A device as in claim 1 in which said amplifier means has a clip attached to one side.

8. A device as in claim 1 in which said amplifier means has a power source connected to it.

9. A device as in claim 8 in which said power source is a battery.

10. A device as in claim 1 in which said connection between said audio production means and said amplifier is wireless.

11. A device as in claim 1 in which said connection between said pickup and said amplifier is wireless.

12. A method for root planning using the device in claim 1.

13. A method as in claim 12 in which said audio production means is headphones.

14. A method as in claim 12 in which said amplifier means has a volume control.

15. A method as in claim 12 in which said pick-up means has a condenser microphone with a receptacle to pick up vibrations from said scaler.

16. A method as in claim 12 in which said audio production means has a volume control.

17. A method as in claim 12 in which said audio production means connects to said amplifier means through a plug being inserted into a plug jack.

18. A method as in claim 12 in which said amplifier means has a clip attached to one side.

19. A method as in claim 12 in which said amplifier means has a power source connected to it.

20. A dental device comprising scaler attached to a pick-up means through a connecting means, said pick-up means connected to an amplifier means which is connected to audio production means, where said amplifier means has a volume control, where said pick-up means has a condenser microphone with a receptacle to pick up vibrations from said scaler and where said amplifier means has a power source connected to it.
